(19) United States
(12) Patent Application Publication
(10) Pub. No.: US 2021/0063854 A1
(43) Pub. Date: Mar. 4, 2021

(54) WAVELENGTH CONVERSION MODULE AND PROJECTION DEVICE

(71) Applicant: Coretronic Corporation, Hsin-Chu (TW)

(72) Inventors: Wen-Jui Huang, Hsin-Chu (TW); Shi-Wen Lin, Hsin-Chu (TW); Tsung-Ching Lin, Hsin-Chu (TW)

(73) Assignee: Coretronic Corporation, Hsin-Chu (TW)

(21) Appl. No.: 17/005,301

(22) Filed: Aug. 27, 2020

(30) Foreign Application Priority Data
Sep. 3, 2019 (CN) 201921448899.8

(51) Int. Cl. G03B 21/20; G03B 21/16; F21K 9/64; F21V 29/58

(52) U.S. Cl. CPC G03B 21/204; F21V 29/58; F21K 9/64; G03B 21/16

(57) ABSTRACT

The disclosure provides a wavelength conversion module and a projection device. The wavelength conversion module includes a housing, a wavelength conversion element, and a heat transfer fluid. The housing has a sealed space. The wavelength conversion element is disposed in the sealed space of the housing. The heat transfer fluid is filled in the sealed space of the housing, wherein the thermal conductivity of the heat transfer fluid is at least 5 times the thermal conductivity of air. The wavelength conversion module and the projection device can provide better heat dissipation capability to improve the optical reaction efficiency of the wavelength conversion element, and have better projection quality and product competitiveness.

### CROSS-REFERENCE TO RELATED APPLICATION

This application claims the priority benefit of China application Ser. No. 201921448899.8, filed on Sep. 3, 2019. The entirety of the above-mentioned patent application is hereby incorporated by reference herein and made a part of this specification.

### BACKGROUND

### Technical Field

The disclosure relates to an optical module and a projection device, and more particularly to a wavelength conversion module and a projection device including the wavelength conversion module.

### Description of Related Art

In a device of a solid state illumination laser (SSI Laser) projector, a phosphor wheel is located on a transmission path of an illumination beam of a light source module, and a blue laser light source is projected through a projection lens to a light conversion region of the phosphor wheel to excite a yellow light source, thereby achieving the purpose of synthesizing white light. However, the phosphor may be contaminated with dust during rotation, which causes its optical efficiency to decrease, so the phosphor wheel is mostly disposed in a sealed housing to prevent dust from entering. However, the energy loss caused by the light conversion on the turntable and the heat generated by the motor driving the rotation of the turntable will increase the temperature inside the sealed housing, which in turn causes the optical reaction efficiency of the phosphor to decrease due to high temperature, and the risk of damage of the phosphor wheel is also increased. Further, in order to solve the above problem, it is known to add a fan or a heat dissipation fin in the sealed housing to transmit the heat in the housing to the outside. However, the above method not only requires an increase in the sealed housing space and an additional part cost but also increases product development costs.

The information disclosed in this background section is only for enhancement of understanding of the background of the described technology and therefore it may contain information that does not form the prior art that is already known to a person of ordinary skill in the art. Further, the information disclosed in the background section does not mean that one or more problems to be resolved by one or more embodiments of the invention were acknowledged by a person of ordinary skill in the art.

### SUMMARY

The disclosure provides a wavelength conversion module which has better heat dissipation capability and can improve the optical reaction efficiency of the wavelength conversion element.

The disclosure provides a projection device which includes the above wavelength conversion module and has better projection quality and product competitiveness.

Other objects and advantages of the disclosure may be further understood from the technical features disclosed herein.

In order to achieve one or a part or all of the above or other objects, an embodiment of the disclosure provides a wavelength conversion module including a housing, a wavelength conversion element, and a heat transfer fluid. The housing has a sealed space. The wavelength conversion element is disposed in the sealed space of the housing. The heat transfer fluid is filled in the sealed space of the housing, wherein the thermal conductivity of the heat transfer fluid is at least 5 times the thermal conductivity of air.

In order to achieve one or a part or all of the above or other objects, an embodiment of the disclosure provides a projection device including a light emitting unit, a wavelength conversion module, a light valve, and a projection lens. The light emitting unit is configured to emit an illumination beam. The wavelength conversion module is disposed on a transmission path of the illumination beam and includes a housing, a wavelength conversion element, and a heat transfer fluid. The housing has a sealed space. The wavelength conversion element is disposed in the sealed space of the housing. The heat transfer fluid is filled in the sealed space of the housing, wherein the thermal conductivity of the heat transfer fluid is at least 5 times the thermal conductivity of air. The light valve is disposed on a transmission path of the illumination beam and is configured to convert the illumination beam into an image beam. The projection lens is disposed on a transmission path of the image beam and is configured to convert the image beam into a projection beam.

Based on the above, the embodiments of the disclosure have at least one of the following advantages or effects. In the design of the wavelength conversion module of the disclosure, the heat transfer fluid is filled in the sealed space of the housing, and the thermal conductivity of the heat transfer fluid is at least 5 times the thermal conductivity of air. Therefore, the heat transfer fluid can effectively lower the temperature in the sealed space to lower the temperature of the wavelength conversion element disposed in the sealed space, thereby improving the optical reaction efficiency of the wavelength conversion element. In addition, the projection device using the wavelength conversion module of the disclosure can have better projection quality and product competitiveness.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a projection device according to the disclosure.

FIG. 2 is a schematic diagram of the wavelength conversion module of FIG. 1.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

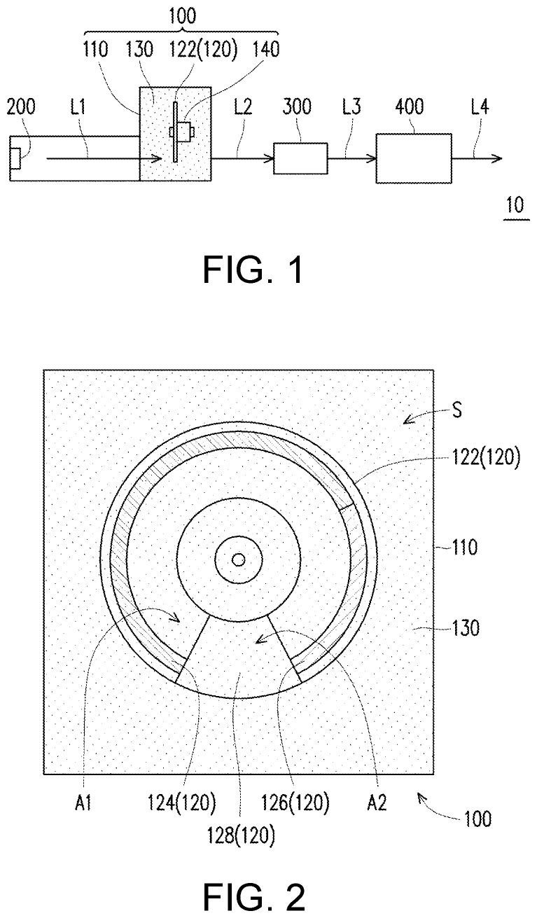

FIG. 1 is a schematic diagram of a projection device according to the disclosure. Please refer to FIG. 1 first. In the embodiment, a projection device 10 includes a wavelength conversion module 100, a light emitting unit 200, a light valve 300, and a projection lens 400. The light emitting unit 200 is configured to emit an illumination beam L1 which, after being converted by the wavelength conversion module 100 and the light valve 300, is projected through the projection lens 400 to a display screen (not shown) outside the projection device 10. Here, the light emitting unit 200 is, for example, a light emitting diode, a laser diode, a high pressure mercury lamp, or other suitable light sources. Preferably, the light emitting unit 200 is a blue light emitting diode, but it is not limited thereto.

The wavelength conversion module 100 is, for example, a phosphor wheel configured to receive the illumination beam L1, the wavelength conversion module 100 is located on a transmission path of the illumination beam L1, and the wavelength conversion module 100 can convert the light wavelength of the illumination beam L1 to form a wavelength converted beam, and the illumination beam L1 and the wavelength converted beam can be mixed to form a mixed beam L2. The light valve 300 is disposed on the transmission path of the illumination beam L1 and is configured to convert the illumination beam L1 into an image beam L3. The projection lens 400 is disposed on a transmission path of the image beam L3 and is configured to convert the image beam L3 into a projection beam L4.

In more detail, the light valve 300 used in the embodiment is, for example, a reflective optical modulator, such as a liquid crystal on silicon panel (LCoS panel) or a digital micro-mirror device (DMD). In an embodiment, the light valve 300 is, for example, a transmissive optical modulator, such as a transparent liquid crystal panel, an electro-optical modulator, a magneto-optic modulator, or an acousto-optic modulator (AOM), but the embodiment does not limit the form and type of the light valve 300. Regarding the method by which the light valve 300 converts the illumination beam L1 into the image beam L3, the detailed steps and implementation method thereof can be sufficiently taught, suggested, and implemented by the general knowledge in the art, and therefore will not be described herein. In addition, the projection lens 400 includes, for example, a combination of one or more optical lenses having a diopter, such as various combinations of non-planar lenses including, for example, biconcave lenses, biconvex lenses, concave-convex lenses, convex-concave lenses, plane-convex lenses, and plane-concave lenses. In an embodiment, the projection lens 400 may include planar optical lenses to convert the image beam from the light valve 300 into the projection beam and projects it outside the projection device 10 in a reflective or transmissive manner. Regarding this, the embodiment does not limit the form and type of the projection lens 400.

FIG. 2 is a schematic diagram of the wavelength conversion module of FIG. 1. For convenience of description, the driving component of FIG. 1 is omitted in FIG. 2. Please refer to both FIG. 1 and FIG. 2. The wavelength conversion module 100 of the embodiment includes a housing 110, a wavelength conversion element 120, and a heat transfer fluid 130. The housing 110 has a sealed space S, and the wavelength conversion element 120 is disposed in the sealed space S of the housing 110. Here, the sealed space S is, for example, an airtight closed space and can prevent dust outside the housing 110 from entering the housing 110 and adhering to the wavelength conversion element 120, thereby improving the reliability of the wavelength conversion module 100.

More specifically, the wavelength conversion element 120 of the embodiment includes a substrate 122, at least one wavelength conversion material layer (two wavelength conversion material layers 124, 126 are schematically shown), and a light transmission plate 128. The substrate 122 is, for example, a metal substrate and has a first region A1 and a second region A2 disposed adjacent to each other, the first region A1 and the second region A2 are adjacently disposed, the first region A1 is a wavelength conversion region, and the second region A2 is a non-wavelength conversion region. Here, the second region A2 of the substrate 122 is embodied as a hollow opening. The light transmission plate 128 is located in the second region A2 to define a disk shape with the substrate 122. The first region A1 and the second region A2 of the substrate 122 alternately cut into the transmission path of the illumination beam L1 of FIG. 1. The wavelength conversion material layers 124, 126 are disposed on the substrate 122 and located in the first region A1, and the wavelength conversion material layers 124, 126 are both, for example, phosphor layers, configured to convert the wavelength of the illumination beam L1 of FIG. 1 and respectively generate converted beams of different wavelengths. In addition, the wavelength conversion module 100 of the embodiment further includes a driving component 140 connected to the substrate 122 of the wavelength conversion element 120 to drive the substrate 122 to rotate. The driving component 140 is, for example, a motor, but it is not limited thereto.

When the substrate 122 rotates, the wavelength conversion material layers 124, 126 located in the first region A1 and the light transmission plate 128 located in the second region A2 are sequentially moved to the transmission path of the illumination beam L1 shown in FIG. 1. When the light transmission plate 128 located in the second region A2 enters the transmission path of the illumination beam L1, the illumination beam L1 passes through the light transmission plate 128 and is transmitted to the light valve 300. When the wavelength conversion material layers 124, 126 located in the first region A1 sequentially enter the transmission path of the illumination beam L1 of FIG. 1, the wavelength conversion material layers 124, 126 convert the wavelength of the illumination beam L1. Here, the wavelength conversion material layer 124 is configured to convert the illumination beam L1 into a first converted beam having a first wavelength (such as yellow light), and the wavelength conversion material layer 126 is configured to convert the illumination beam L1 into a second converted beam having a second wavelength (such as green light), and the first wavelength is different from the second wavelength. The illumination beam L1 of FIG. 1 may also pass directly through the substrate 122 via the second region A2 on the substrate 122. In addition, the first converted beam (yellow light) and the second converted beam (green light) are transmitted to other optical components by, for example, reflection by the substrate 122, and then converged with the illumination beam L1 (blue light) passing through the substrate 122 to form the mixed beam L2.

Of course, in other embodiments not shown, the wavelength conversion module may not have a driving component; that is, the wavelength conversion module is not a wheel type and does not rotate, which is still within the scope of the disclosure.

In particular, the heat transfer fluid 130 of the embodiment is filled in the sealed space S of the housing 110, and the thermal conductivity of the heat transfer fluid 130 is at least 5 times the thermal conductivity of air. For example, in one embodiment, the heat transfer fluid 130 is, for example, helium gas, and the thermal conductivity of helium gas is greater than 5 to 6 times the thermal conductivity of air. Since the thermal conductivity of helium gas is greater than 5 to 6 times the thermal conductivity of air, the wavelength conversion element 120 in the sealed space S thus increases the heat dissipation capability by 1 to 2 times. In another embodiment, the heat transfer fluid 130 may be, for example, an antifreeze liquid, and the thermal conductivity of the antifreeze liquid is greater than 10 times the thermal conductivity of air. Since the thermal conductivity of the antifreeze liquid is much greater than the thermal conductivity of air, the surface temperature of the wavelength conversion element 120 located in the sealed space S can be effectively lowered. It should be noted that since the density of helium gas is low, when the wavelength conversion element 120 located in the sealed space S rotates, noise is unlikely to be transmitted out of the housing 110, and noise can be effectively reduced. In addition, helium gas can also effectively prevent the oxidation phenomena of the wavelength conversion element 120 and the driving component 140, thereby increasing the service life of the wavelength conversion module 100.

In a simulation embodiment, at a rotational speed of 7200 rpm, it is known that the surface temperature of the wavelength conversion element in a sealed space filled with air is 230 degrees, and in the embodiment, the surface temperature of the wavelength conversion element 120 in the sealed space S filled with the heat transfer fluid 130 is 140 degrees. That is, the sealed space S filled with the heat transfer fluid 130 of the embodiment can effectively lower the surface temperature of the wavelength conversion element 120 by at least 40% compared with the sealed space filled with air.

In short, the wavelength conversion module 100 of the embodiment can improve the heat dissipation capability of the wavelength conversion module 100 by changing the gas property in the sealed space S (i.e., by filing the heat transfer fluid 130 that is not air) without disposing additional heat dissipation components and heat dissipation fins. In this way, the risk of damage of the wavelength conversion module 100 due to high temperature can be reduced, and the optical reaction efficiency of the wavelength conversion module 100 can be improved. Moreover, since the embodiment does not need to increase the sealed housing space or to dispose additional heat dissipation components and heat dissipation fins, both the wavelength conversion element 120 and the driving component 140 can be reduced in size. In addition, the projection device 10 using the wavelength conversion module 100 of the embodiment does not need to increase the sealed housing space or to dispose additional heat dissipation components and heat dissipation fins; therefore, in addition to the improved projection quality due to the good heat dissipation effect of the wavelength conversion module 100, it can also have better product competitiveness.

In summary, the embodiments of the disclosure have at least one of the following advantages or effects. In the design of the wavelength conversion module of the disclosure, the heat transfer fluid is filled in the sealed space of the housing, and the thermal conductivity of the heat transfer fluid is at least 5 times the thermal conductivity of air. Therefore, the heat transfer fluid can effectively lower the temperature in the sealed space to lower the temperature of the wavelength conversion element disposed in the sealed space, thereby improving the optical reaction efficiency of the wavelength conversion element. In addition, the projection device using the wavelength conversion module of the disclosure can have better projection quality and product competitiveness.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A wavelength conversion module comprising a housing, a wavelength conversion element, and a heat transfer fluid, wherein
the housing has a sealed space,
the wavelength conversion element is disposed in the sealed space of the housing, and
the heat transfer fluid is filled in the sealed space of the housing, wherein the thermal conductivity of the heat transfer fluid is at least 5 times the thermal conductivity of air.

2. The wavelength conversion module according to claim 1, wherein the heat transfer fluid is helium gas, and the thermal conductivity of the heat transfer fluid is greater than 5 to 6 times the thermal conductivity of air.

3. The wavelength conversion module according to claim 1, wherein the heat transfer fluid is an antifreeze liquid.

4. The wavelength conversion module according to claim 1, wherein the wavelength conversion element comprises:
a substrate having a first region and a second region disposed adjacent to each other;
at least one wavelength conversion material layer disposed on the substrate and located in the first region; and
a light transmission plate located in the second region to define a disk shape with the substrate.

5. The wavelength conversion module according to claim 4, further comprising:
a driving component connected to the substrate of the wavelength conversion element to drive the substrate to rotate.

6. A projection device comprising a light emitting unit, a wavelength conversion module, a light valve, and a projection lens, wherein
the light emitting unit is configured to emit an illumination beam,
the wavelength conversion module is disposed on a transmission path of the illumination beam and comprises a housing, a wavelength conversion element, and a heat transfer fluid, wherein
the housing has a sealed space,
the wavelength conversion element is disposed in the sealed space of the housing, and
the heat transfer fluid is filled in the sealed space of the housing, wherein the thermal conductivity of the heat transfer fluid is at least 5 times the thermal conductivity of air,
the light valve is disposed on a transmission path of the illumination beam and is configured to convert the illumination beam into an image beam, and
the projection lens is disposed on a transmission path of the image beam and is configured to convert the image beam into a projection beam.

7. The projection device according to claim 6, wherein the heat transfer fluid is helium gas, and the thermal conductivity of the heat transfer fluid is greater than 5 to 6 times the thermal conductivity of air.

8. The projection device according to claim 6, wherein the heat transfer fluid is an antifreeze liquid.

9. The projection device according to claim 6, wherein the wavelength conversion element comprises:
a substrate having a first region and a second region disposed adjacent to each other;
at least one wavelength conversion material layer disposed on the substrate and located in the first region; and
a light transmission plate located in the second region to define a disk shape with the substrate.

10. The projection device according to claim 9, further comprising:
a driving component connected to the substrate of the wavelength conversion element to drive the substrate to rotate.
